(19) United States
(12) Patent Application Publication
(10) Pub. No.: US 2025/0292131 A1
(43) Pub. Date: Sep. 18, 2025

(54) QUANTUM DEVICE INITIALISATION

(71) Applicant: Riverlane Ltd, Cambridge (GB)

(72) Inventor: Christoph SUNDERHAUF, Cambridge (GB)

(73) Assignee: Riverlane Ltd, Cambridge (GB)

(21) Appl. No.: 19/072,299

(22) Filed: Mar. 6, 2025

(30) Foreign Application Priority Data
Mar. 14, 2024 (GB) 2403671.7

(51) Int. Cl. G06N 10/20

(52) U.S. Cl. CPC G06N 10/20

(57) ABSTRACT

A quantum computing system and associated method of preparing a plurality of quantum devices are disclosed. A compiling system of the quantum computing system is configured to receive a quantum state specification comprising a plurality of state variables defining a quantum state, determine a compressed representation of the quantum state, and send the compressed representation to a control system of the quantum computing system. The control system is configured to receive the compressed representation of the quantum state and use the compressed representation to prepare the plurality of quantum devices according to the quantum state.

### CROSS-REFERENCE TO RELATED APPLICATIONS

The present application claims priority under 35 U.S.C. § 119 (a) to United Kingdom Patent Application No. GB 2403671.7, filed Mar. 14, 2024, titled “Quantum Device Initialisation,” which is hereby incorporated by reference in its entirety.

### FIELD OF THE DISCLOSURE

The present disclosure relates to quantum computation.

### BACKGROUND

Quantum computers have the potential to perform computations that would be intractable on even the most powerful classical computers. Instead of representing information using classical bits, quantum computers generally use qubits (quantum bits) that can be in a simultaneous superposition of multiple quantum states.

As quantum computing technology matures, there is an increasing acceptance that high-quality qubits alone will not be sufficient to achieve quantum advantage. For example, large-scale fault-tolerant quantum computation will require advances in areas such as quantum error correction and quantum control, which are generally handled by classical computing devices.

Another area that could undermine quantum advantage is initialising quantum devices in specific quantum states. Quantum algorithms often require specific quantum states to be initialised on a quantum computer, and preparing these states can require large numbers of qubits and quantum operations. There is therefore a need for improved methods and devices for preparing quantum states on a quantum computer.

### SUMMARY

According to a first aspect of the disclosure, there is provided a quantum computing system comprising: a compiling system; and a quantum processing unit comprising a control system coupled to a plurality of quantum devices, wherein the compiling system is configured to: receive a quantum state specification comprising a plurality of state variables defining a quantum state; determine a compressed representation of the quantum state, wherein determining the compressed representation of the quantum state comprises: splitting the plurality of state variables into a plurality of state variable subsets; and determining a respective polynomial approximation representing each respective subset of the plurality of state variable subsets, and send the compressed representation to the control system, and wherein the control system is configured to: receive the compressed representation of the quantum state; and use the compressed representation to prepare the plurality of quantum devices according to the quantum state.

According to a second aspect of the disclosure, there is provided a method of initialising a plurality of quantum devices in a quantum computing system, the method comprising: receiving, at a compiling system of the quantum computing system, a quantum state specification comprising a plurality of state variables defining a quantum state; determining, at the compiling system, a compressed representation of the quantum state, wherein determining the compressed representation of the quantum state comprises: splitting the plurality of state variables into a plurality of state variable subsets; and determining a respective polynomial approximation representing each respective subset of the plurality of state variable subsets, sending the compressed representation from the compiling system to a control system of the quantum computing system; and using the compressed representation, at the control system, to prepare the plurality of quantum devices according to the quantum state.

The second aspect of the disclosure provides the same benefits as the first aspect of the disclosure. Any feature described in combination with the first aspect of the disclosure may also be combined with the second aspect of the disclosure.

According to a third aspect of the disclosure, there is provided a computer-readable medium (such as a non-transitory computer readable medium) comprising instructions which, when executed by a quantum computing system comprising a compiling system, a control system and a plurality of quantum devices, cause the quantum computing system to carry out the method of the second aspect of the disclosure.

### BRIEF DESCRIPTION OF THE DRAWINGS

Examples of the present disclosure will now be described in detail with reference to the accompanying drawings, in which:

FIG. 1 is a schematic of a quantum computing system;

FIG. 2 is a flowchart showing a method of preparing quantum devices according to a quantum state; and

FIG. 3 shows an example of a quantum circuit for use in preparing quantum devices according to a quantum state.

### DETAILED DESCRIPTION

Preparing quantum states exactly on a quantum computer requires substantial quantum resources, which could undermine any potential quantum advantage. Techniques described herein address this problem by determining a compressed representation of the quantum state that can be represented using fewer parameters than the exact representation. As a result, quantum states may be more efficiently prepared by utilizing fewer resources.

Existing approaches for approximating quantum states fit a single high-degree polynomial to all state variables. Compared to these approaches, by splitting the state variables into multiple subsets each with a different polynomial approximation, the present disclosure facilitates compression with improved accuracy (more granular polynomial fitting/approximation is achieved by focusing on subsets of state variables rather than attempting to approximate all state variables with a single polynomial) and with lower-degree polynomials (which are generally easier/faster to fit compared to higher-degree polynomials and require fewer coefficients to represent).

Instead of being defined by the state variables, the compressed representation is defined by the polynomial approximations (e.g. coefficients of the polynomial approximations). The compressed representation is used to prepare the quantum devices in a state that approximates the quantum state (i.e. the target/desired quantum state defined by the state specification). The compressed representation is therefore a lossy compression of the quantum state.

Due to the combination of improved approximation accuracy and lower-degree polynomials, the present disclosure enables a greater level of compression (i.e. requires fewer polynomial coefficients) to achieve the same degree of accuracy as existing approaches. In addition, the use of multiple polynomial approximations is more versatile and can handle discontinuities between state variables (i.e. large jumps between successive state variables).

Using the compressed representation to prepare the plurality of quantum devices according to the quantum state involves using the compressed representation (e.g. the polynomial coefficients or control signals derived therefrom) to prepare the plurality of quantum devices in a state that approximates the desired quantum state (i.e. to within some predetermined accuracy—the prepared state approximates the desired quantum state due to the lossy nature of the compression). One skilled in the art will appreciate that various quantum circuits may be executed to prepare quantum devices based on polynomial coefficients.

The quantum devices may be any quantum devices capable of storing quantum information (i.e. any devices suitable for encoding information using quantum computational states). The quantum devices may be qubits. Alternatively, the quantum devices may be other devices capable of storing quantum information, such as qudits or qutrits. While the description herein will primarily refer to qubits, any reference herein to qubits should be understood to also encompass other types of quantum devices unless explicitly stated otherwise.

A quantum computing system (also referred to herein as a quantum computer) is a computing system that exploits quantum mechanical phenomena (i.e. using quantum devices).

A quantum processing unit is a device (such as a chip) with one or more quantum devices (such as qubits) that are controlled by a control system (e.g. the control system may transmit RF pulses for performing operations and readout on the quantum devices). A control system (also referred to as a quantum control system) is generally a classical processing device configured to communicate with quantum devices (e.g. by sending and receiving control signals such as RF pulses) to perform operations such as quantum logic gates and state measurement/readout.

The compiling system is a classical processing system that processes a quantum state specification to generate a compressed representation of the quantum state specification for use by the control system.

The state variables may be coefficients of eigenstates of the quantum state.

The compressed representation may optionally be processed (e.g. by the compiling system, the control system or some other system) from a high level format (e.g. coefficients of the polynomial approximations) into a low level format (such as a series of quantum gate/quantum circuit instructions that utilise the polynomial coefficients to prepare the quantum devices according to the quantum state, e.g. instructions that are derived from/determined based upon the polynomial coefficients, or RF pulses/control signals representing such gate instructions). The compressed representation may therefore comprise polynomial coefficients of the respective polynomial approximations and/or signals or data derived from the polynomial coefficients.

The compressed representation may comprise quantum circuit instructions (i.e. quantum circuit instructions encoding (or otherwise based on) the polynomial approximations).

A polynomial approximation is a polynomial function that can be used to determine approximate values for the state variables. Each polynomial approximation comprises a plurality of polynomial coefficients. Each polynomial approximation has an associated degree (or degree value), which is the highest of the degrees of the polynomial's individual terms with non-zero coefficients (for example, a cubic polynomial of the form c₁+c₂x+c₃x²+c₄x³ has degree three and four polynomial coefficients (which, except for c₄, may optionally be zero). The number of coefficients associated with each polynomial approximation is generally one larger than the degree (a degree-three cubic polynomial has four polynomial coefficients). Coefficients may be zero, and they may be represented as signed or unsigned fixed-point numbers, floating point numbers or integers. The polynomials may optionally have definite parity (i.e. contain only even or only odd coefficients), in which case the number of coefficients associated with each polynomial will be roughly half the degree. Any of the various techniques known to a person skilled in the art may be used to obtain the polynomial approximations, including polynomial regression, curve fitting (e.g. least squares), polynomial interpolation, Chebyshev approximation and the Remez algorithm.

The polynomial approximation may use any suitable polynomial basis such as the monomial basis or Chebyshev polynomials.

Preparing the plurality of quantum devices according to the quantum state may involve transmitting control signals to the quantum devices based on the polynomial coefficients (e.g. control signals to perform quantum operations such as phase rotations based on the coefficient values).

The plurality of state variables may have an associated size value, and a size of each of the plurality of state variable subsets may be equal to the size value. The size value may be a size of a data array encoded in the quantum state (e.g. a number of rows/columns) or may be some other size value, such as a size of a physical system represented by the quantum state.

Many quantum states of interest have a natural grouping of values corresponding to a size value of a physical system of interest. For example, a quantum state may include values representing a two-dimensional (or higher dimensional) physical parameter, such as pressure. When represented as a two-dimensional data array, such values will generally be relatively smooth (i.e. relatively small changes between adjacent values). However, when the data is transposed into a one-dimensional quantum state (which is a vector rather than a two-dimensional matrix), large changes in value can occur between adjacent values where transitions between matrix rows occur. Finding polynomial approximations that accommodate such transitions is difficult and generally reduces the accuracy of the fitting. Splitting the state variables into subsets based on a size value (e.g. a size an original data array, such as the width/number of columns) ensures that each subset contains only smooth transitions between adjacent values, thereby providing accurate fittings with low-degree polynomials, which reduces the number of coefficients required to approximate the quantum state, thereby increasing the level of compression and reducing the resources required to prepare the quantum state.

All respective polynomial approximations may optionally have equal polynomial degree.

A total number of polynomial coefficients associated with all respective polynomial approximations is preferably less than a total number of state variables in the plurality of state variables.

Each of the plurality of state variable subsets preferably comprises multiple state variables.

Each of the plurality of state variable subsets may comprise an equal number of state variables (i.e. all respective state variable subsets have equal size).

Optionally, each respective state variable subset may comprise a plurality of sequential state variables. That is, each state variable subset may comprise an ordered subsequence of the ordered sequence of all of the state variables.

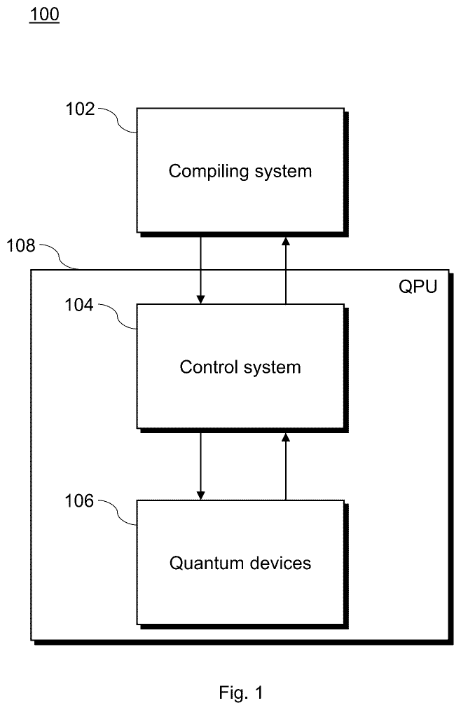

A schematic of an illustrative quantum computing system 100 for performing the methods of the present disclosure is shown in FIG. 1. The quantum computing system 100 comprises a plurality of quantum devices 106, such as physical or logical qubits.

A quantum computing system (also referred to herein as a quantum computer) is a computing system that exploits quantum mechanical phenomena (i.e. using quantum devices) to perform computational operations. The quantum devices may be any quantum devices capable of storing quantum information (i.e., any devices suitable for encoding information using quantum computational states). The quantum devices may be qubits. Alternatively, the quantum devices may be other devices capable of storing quantum information, such as qudits or qutrits. While the description herein will primarily refer to qubits, any reference herein to qubits should be understood to also encompass other types of quantum devices unless explicitly stated otherwise.

The quantum computing system 100 comprises a plurality of physical quantum devices 106. The quantum devices 106 may include data qubits used to encode logical qubit states, and auxiliary qubits (or syndrome qubits) used to perform syndrome measurements for QEC. These different types of qubits may differ only in the way that their states are manipulated and interpreted; that is, the data qubits and auxiliary qubits may be physically implemented in the exact same way in some embodiments, and only differ in their usage. Unless specified otherwise, references herein to qubits should be understood to refer to physical qubits rather than logical qubits.

Hereinafter the quantum devices 106 may be referred to as qubits, although one skilled in the art will appreciate that the techniques described herein are also applicable to quantum computing systems that use other quantum devices, such as qutrits and qudits. Accordingly, it should be understood that any reference herein to qubits is applicable to any type of quantum devices that can be used to encode quantum information.

As described above, qubits are quantum devices, such as a multi-level quantum device, capable of storing quantum information (i.e. any devices suitable for encoding information using quantum states). The quantum states of the qubit may for instance include electronic states, polarization states, vibrational states, rotational states, or spin states. For example, the quantum devices 106 may be superconducting qubits, neutral atom qubits or any other type of qubit. In some cases, a qubit may be a logical qubit formed from multiple physical qubits, such as a superconducting resonator coupled to an ancilla superconducting charge qubit.

In the case of superconducting qubits, quantum information may be represented by the presence or absence of an electronic charge (e.g. the presence of absence of a Cooper-pair, which is a pair of bound electrons). The quantum state of a superconducting qubit can be manipulated through the application of shaped microwave pulses, which can effect operations such as quantum logic gates and state readout.

In the case of neutral atom qubits, quantum information may be represented by occupation of different electron energy levels. For example, a first energy level (e.g. the ground state or some excited state) may represent a first quantum state, and a different energy level may represent a different quantum state. The quantum state of a neutral atom qubit can be manipulated through the application of laser pulses, whereby the frequency and duration of the pulse can be carefully controlled to cause transitions between select energy levels. Neutral atom qubits can be measured by detecting photon emission (i.e. electromagnetic radiation, which may be in the visible spectrum) when the atom is irradiated with suitable laser pulses.

Unlike classical bits (which can be in either a zero or one state), qubits exploit the phenomenon of quantum superposition in order to enable them to exist in multiple states at once. Quantum superposition allows a quantum mechanical system to simultaneously occupy multiple different states; only when the state of the system is observed/measured does the system “collapse” into a single definite state.

For example, a quantum zero state (denoted |0 [symbol] ) may correspond to the absence of a Cooper pair (in the case of superconducting qubits) or occupation of a first electron energy level (in the case of neutral atom qubits), and a quantum one state (denoted |1 [symbol] ) may correspond to the presence of a Cooper pair or occupation of a second energy level. Quantum mechanics allows qubits to simultaneously be in a combination of the |0 [symbol] and |1 [symbol] states until they are observed (at which point they “collapse” into a single state).

This combination of the |0 [symbol] and | 1 [symbol] basis states for a single qubit may be represented as a quantum wavefunction |ψ [symbol] =α|0 [symbol] +β|1 [symbol] , where |ψ [symbol] represents the qubit state and α and β represent the amplitudes of the |0 [symbol] and |1 [symbol] states respectively. The amplitudes may be positive or negative, and they may have complex components. Conceptually, a single qubit state can be visualized as a position on a unit sphere known as a “Bloch sphere”. Some qubits can also be controlled to be in other states, such as higher or lower energy states than the |0 [symbol] and |1 [symbol] basis states, for the purposes of computation, such as the Rydberg state in neutral atoms, described below.

In addition to superposition, qubits can also exploit the phenomenon of quantum entanglement, which allows the states of different (potentially spatially separated) quantum mechanical systems to become dependent upon one another. For example, when a first and a second quantum mechanical system are entangled, observation/measurement of one of the systems may cause the other to instantaneously collapse into a state dependent upon the outcome of said observation/measurement. Entanglement between qubits can be realised by applying control signals (e.g. microwave or laser pulses) to a qubit in such a way that the effect upon that qubit is dependent upon the state of one or more other qubits.

In the example of neutral atoms, qubits can be entangled by making use of the “Rydberg blockade” effect in physics. An atom is temporarily excited into a higher Rydberg energy level; it becomes entangled because no other atom in the vicinity can be in the same higher Rydberg energy level.

While there are several different (and equivalent) models of quantum computation, the most prominent model is the circuit model, in which quantum computations are described using quantum logic circuits that are similar to logic circuits used in classical (i.e. non-quantum) computation.

For example, quantum circuit operations include (among others) an X (or NOT) gate, which flips a |0 [symbol] state to a |1 [symbol] state (and vice-versa), a Z (or phase) gate (which flips the sign of the amplitude of the |1 [symbol] state), and a CNOT (or controlled-NOT) gate, which performs an X gate on a target qubit dependent upon a control qubit being in a |1 [symbol] state. As one skilled in the art will appreciate, the CNOT gate can be used to entangle qubits when the control qubit is in a superposition of the |0 [symbol] and |1 [symbol] states (conceptually, the CNOT gate is activated by the part of the superposition that is in the |1 [symbol] state but not by the part of the superposition that is in the |0 [symbol] state, so the state of the target qubit becomes dependent upon the state of the control qubit).

Because the amplitudes of quantum states can be non-integer values, the number of possible quantum states is unrestricted (i.e. infinite). As such, quantum gates are similarly not restricted to analogues of classical logic operations. Instead, quantum gates can perform arbitrary manipulations of the quantum state, which can be visualised as rotations of the quantum state in the Bloch sphere picture. A quantum gate may therefore be any unitary operation. In practice, arbitrary unitary operations may be approximated by using a finite set of logic gates (e.g. a group of quantum operations known as the “Clifford group” in combination with one other gate that is not an element of the Clifford group). Furthermore, these operations may be performed on groups of physical qubits that encode “logical qubits” as part of an error correction code.

Quantum logic gates may conveniently be represented as matrices, and quantum states may be represented as vectors (normally column vectors).

For example, a quantum state |ψ [symbol] =α|0 [symbol] +β|1 [symbol] may be represented as:

|ψ [symbol] =(αβ).

X, Z and CNOT gates may be represented as:

$$X = ( \begin{matrix}0 & 1 \\ 1 & 0\end{matrix} ) , Z = ( \begin{matrix}1 & 0 \\ 0 & - 1\end{matrix} ) and CNOT = ( \begin{matrix}1 & 0 & 0 & 0 \\ 0 & 1 & 0 & 0 \\ 0 & 0 & 0 & 1 \\ 0 & 0 & 1 & 0\end{matrix} ) ,$$

where the CNOT gate acts upon two quantum states, which can be represented as a stacked column vector.

In general, quantum computing operations can be represented in as a unitary operation in a matrix form (i.e., as a unitary matrix). In some cases, quantum computing may also comprise the application of non-unitary operations (e.g., transitioning from a basis state to a Rydberg state in a neutral atom qubit).

Quantum logic gates can be implemented on physical qubits by applying control pulses (e.g. microwave or laser pulses, depending upon the qubit architecture). In addition to the logic gates described above, other quantum computing operations include state initialisation (i.e. preparing qubits in an initial state, such as a |0 [symbol] state) and state measurement (e.g. measuring whether a qubit is in a |0 [symbol] or |1 [symbol] state—as discussed above, a qubit may be in a superposition of both of these states and collapses into one state when it is measured).

Quantum logic gates cannot be efficiently simulated by a classical computer, which means that quantum computers can perform calculations that would be infeasible on classical computers. For example, the behaviour of quantum mechanical systems can be described by unitary matrices, so quantum computers can simulate these quantum mechanical systems by decomposing these unitary matrices into quantum logic gates that can be performed on the quantum computer. This allows quantum computers to determine molecular properties (such as energy levels) and has applications in areas such as materials development and drug discovery. The output of a quantum computation (e.g. the result of the computation/calculation) is determined by measuring the qubits; when simulating quantum mechanical systems, this measurement may encode a physical parameter, such as an energy level or similar. Quantum computers also have applications outside of quantum simulations, such as factoring numbers (which can be used to decipher encrypted information).

In the example of FIG. 1, the quantum devices 106 are controlled by a control system 104 (also referred to herein as a quantum control system), and both the quantum devices 106 and control system 104 are part of a quantum processing unit (QPU) 108. The control system 104 is generally a classical processing device that transmits control signals to the quantum devices 106 for performing operations on the quantum devices 106 (including measurement operations) and receives measurement information from the quantum devices 106. The measurement information will generally be analogue data signals, although the analogue signals may alternatively be converted to digital signals before being transmitted to the control system 104 in some implementations (e.g. the quantum devices 106 may be provided with one or more analogue-to-digital converters).

The control system 104 may receive high-level instructions and convert these high-level instructions (such as logic gates) into low-level qubit instructions (e.g. microwave pulses etc.), which may be in analogue format.

The illustrated quantum computing system 100 additionally comprises a compiling system 102. The compiling system 102 is operable to receive quantum circuit specifications and quantum state specifications for sending to the control system 104. The compiling system 102 may process the circuit and state specifications to generate updated circuit/state specifications and/or translate high-level circuit/state specifications into low-level machine code or pulse specifications that the control system 104 can use to perform operations on the quantum devices 106 (such as preparing quantum states).

One skilled in the art will appreciate that the quantum computing system 100 may also comprise additional components, including intermediary components positioned between the illustrated components, and that the illustrated components may be connected in a different configuration. For example, the quantum computing system 100 may additionally comprise a decoding system used to perform quantum error correction.

The quantum computing system 100 of FIG. 1 may be operated to prepare the quantum devices 106 according to a quantum state by determining a compressed representation of the quantum state at the compiling system 102 and using the compressed representation at the control system 104 to prepare the quantum devices 106.

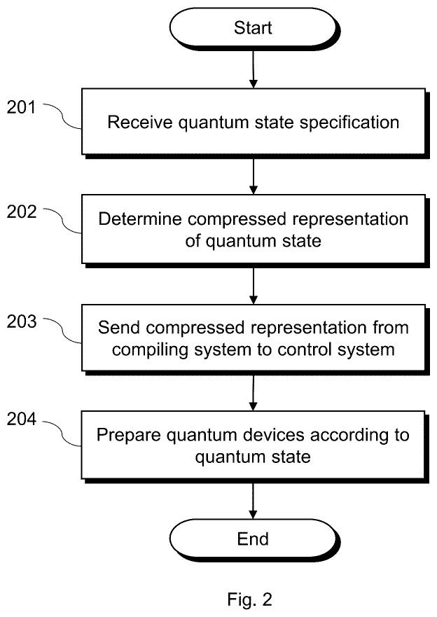

A flowchart of a method for preparing the quantum devices 106 according to a quantum state is shown in FIG. 2. In a first step 201, the compiling system 102 receives a quantum state specification comprising a plurality of state variables defining a quantum state. For example, a quantum state |ψ [symbol] may be defined as

$$\vert ψ 〉 = {\sum }_{i = 0}^{N - 1} {y}_{i} \vert i 〉$$

where yᵢ are the state variables and |i [symbol] are quantum eigenstates (the state variables are coefficients of the eigenstates). The example quantum state |ψ [symbol] involves n=log₂ N qubits and requires N state variables (which may be complex). The state |ψ [symbol] is essentially a superposition of N orthogonal states, with each respective state variable yᵢ representing the amplitude of the corresponding state |i [symbol] . The state variables yᵢ may be real or complex numbers, and the state |ψ [symbol] will preferably be normalised such that (ψ|ψ)=Σᵢ^{N-1}yᵢ*yᵢ=1.

The compiling system 102 then determines a compressed representation of the quantum state in step 202. Preparing the state |Ψ [symbol] exactly on a quantum computer would generally require loading N parameters (e.g. the N coefficients yᵢ, which may be complex numbers) into the quantum computer. Fault-tolerant implementation of such data loading requires substantial quantum resources and risks undermining any potential quantum advantage. Aspects of the present disclosure address this problem by determining a compressed representation of the quantum state that can be represented using fewer parameters than the exact representation.

Determining the compressed representation is performed by splitting the plurality of state variables into a plurality of state variable subsets and determining a respective polynomial approximation representing each respective subset of the plurality of state variable subsets (i.e. a different polynomial representation for each respective state variable subset). A polynomial approximation is a polynomial function that can be used to determine approximate values for the state variables. Each polynomial approximation comprises a plurality of polynomial coefficients. While the examples herein use polynomials in the monomial basis, one skilled in the art will appreciate that alternative bases, such as Chebyshev polynomials, may also be used.

Each state variable subset contains multiple state variables, and the subsets are preferably of the same size (i.e. contain the same number of state variables). The state variables in each subset are preferably sequential (i.e. each subset is preferably a subsequence of the ordered sequence of all state variables) or selected from the ordered sequence of all state variables at regular intervals (e.g. an interval that corresponds to a size value associated with the state variables). In other words, the subsets may be obtained by ordering all state variables (i.e. in ascending or descending order according to the index i) and selecting ordered subsequences (e.g. sequences having a regular size that may correspond to a size value associated with the state variables) or by selecting state variables at given intervals (e.g. every jth element of the ordered sequence, where j may optionally correspond to the size value).

Assuming that the state variables are split into M equal subsets each containing L state variables (such that M×L=N), |ψ [symbol] can be represented as

$$\vert ψ 〉 = {\sum }_{i = 0}^{N - 1} {y}_{i} \vert i 〉 = {\sum }_{l = 0}^{L - 1} {\sum }_{m = 0}^{M - 1} {y}_{m L + l} \vert m L + l 〉 .$$

Each subset of state variables (i.e. each subset having a particular value of m) can then be processed independently to find a polynomial function that approximates the values of the state variables. For example, the first subset (m=0) has L state variables y₀, . . . , y_{L-1}. Conventional fitting techniques can be used to determine a polynomial function, p₀(x) that approximates these state variables such that

$${y}_{l} \approx {p}_{0} ( l / L ) , 0 \leq l < L .$$

This process can be repeated for each value of m to obtain M polynomial functions pₘ(x) for 0≤m<M such that

$${y}_{m L + l} \approx {p}_{m} ( l / L ) , 0 \leq m < M , 0 \leq l < L .$$

Each polynomial function pₘ(x) will have an associated degree dₘ (i.e. the highest of the degrees of the polynomial's individual terms with non-zero coefficients); the degree of a polynomial function determines how many coefficients are required to define the polynomial (each polynomial approximation generally requires dₘ+1 coefficients to represent it rather than the L parameters that would be required to represent the state values approximated by that polynomial, although some polynomials (e.g. those with definite parity) may require fewer coefficients). To ensure that the compression procedure reduces the number of variables required to represent the quantum state, the total number of polynomial coefficients should preferably be less than the number of state variables. One way to ensure this is by selecting polynomials having equal degree d with (d+1)×M<N (or equivalently, to have d+1<L). Increasing the value of d will generally lead to more accurate approximation of the quantum state at the cost of requiring more resources to identify polynomials and to prepare the quantum state.

Once the compressed representation has been determined, the compiling system 102 sends the compressed representation to the control system 104 in step 203, possibly via one or more intermediate devices. The compressed representation may optionally be processed (e.g. by the compiling system 102, the control system 104 or some other system) from a high level format (i.e. the coefficients of the polynomial approximations) into a low level format (such as a series of quantum gate/quantum circuit instructions that utilise the polynomial coefficients (i.e. are derived from/determined based upon the polynomial coefficients) to prepare the quantum devices according to the quantum state, or RF pulses/similar control signals representing such gate instructions).

The compressed representation of the quantum state is received at the control system 104, and in step 204 the control system 104 uses the compressed representation to prepare the quantum devices according to the quantum state. In other words, the control system 104 uses the information encoded in the compressed representation (e.g. the polynomial coefficients, or quantum gates/RF signals that are determined based on the polynomial coefficients) to prepare the quantum devices in a state that approximates the desired quantum state (e.g. within a predetermined accuracy, which can be imposed when determining the compressed representation of the quantum state).

For instance, the control system 104 may generate, based on the compressed representation of a quantum state, one or more signals and direct those signals to the quantum devices 106 to prepare the quantum devices in the quantum state. Such signals may, for example, comprise microwave pulses in the case where the quantum devices are superconducting qubits, or optical pulses in the case where the quantum devices are neutral atoms in an optical trap.

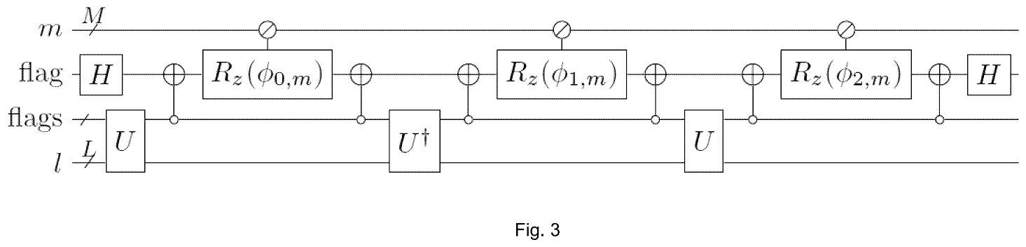

Preparing the quantum devices according to the quantum state can be performed using a quantum circuit such as the quantum circuit 300 shown in FIG. 3, which shows an example of a quantum circuit that can be used to prepare the quantum devices for polynomial approximations of degree three having definite parity and real amplitudes.

The quantum circuit 300 involves a quantum singular value transformation (QSVT) circuit with the block encoding U, where

$$U = ( \begin{matrix}0 / L & & & & \\ & 1 / L & & & \\ & & 2 / L & & \\ & & & ⋱ & \\ & & & & ( L - 1 ) / L\end{matrix} ) .$$

Multi-controlled rotations by phase factors ϕ_{i,m} (where i=0, . . . , d−1) are performed dependent upon (i.e. controlled by) the top register (forward slashes on horizontal qubit lines denote registers of qubits). The phase factors (which can be determined using techniques such as those disclosed in Generalized Quantum Signal Processing, D. Motlagh et al., arXiv:2308.01501 [quant-ph], which is hereby incorporated by reference) determine which polynomial is applied by the QSVT circuit, so there is a different polynomial pₘ(x) for each m. The flag qubits are initialised and postselected as zero. The symbol [symbol] on a controlled operation represents multiplexed control, i.e. where the operation depends upon the state of the qubit register (for example, if the control register is in state m, the operation R_{z}(ϕ_{i,m}) is performed on the target qubit/register).

Using the quantum circuit 300 of FIG. 3 provides a block encoding of the desired diagonal matrix:

$$( \begin{matrix}{p}_{0} ( \frac{0}{L} ) & & & & & & \\ & ⋱ & & & & & \\ & & {p}_{0} ( \frac{L - 1}{L} ) & & & & \\ & & & ⋱ & & & \\ & & & & {p}_{M - 1} ( \frac{0}{L} ) & & \\ & & & & & ⋱ & \\ & & & & & & {p}_{M - 1} ( \frac{L - 1}{L} )\end{matrix} ) .$$

This matrix can be applied to an equal superposition quantum state (e.g. prepared in the top and bottom registers of qubits in FIG. 3) and postselecting the flag qubits in the |0) state to prepare qubits according to the desired quantum state (postselection may necessitate multiple attempts to obtain the desired state—one skilled in the art will appreciate that various approaches can be used to increase the success probability).

One skilled in the art will appreciate that various methods and quantum circuits can utilised with the compressed representation to prepare the plurality of quantum devices according to the quantum state, and the circuit of FIG. 3 is merely one example of such a quantum circuit. For example, one could instead use generalized quantum eigenvalue transformation (GQET) techniques (or any other QSVT-like algorithm) to perform polynomial transformations as determined by phase factors.

In addition, while the above example uses polynomial functions that act on arguments (inputs) of the form l/L, one skilled in the art will recognise that alternative approaches may use different forms of arguments, such as block encodings of the form sin (l/L) (i.e. with y_{l,m}≈pₘ(sin (l/L), in which case a block encoding U′ can be used instead of U, where

$${U}^{′} = ( \begin{matrix}sin ( 0 / L ) & & & & \\ & sin ( 1 / L ) & & & \\ & & sin ( 2 / L ) & & \\ & & & ⋱ & \\ & & & & sin ( ( L - 1 / L )\end{matrix} )$$

and the desired block encoding is

$$( \begin{matrix}{p}_{0} ( sin ( 0 / L ) ) & & & & & & \\ & ⋱ & & & & & \\ & & {p}_{0} ( sin ( ( L - 1 ) / L ) ) & & & & \\ & & & ⋱ & & & \\ & & & & {p}_{M - 1} ( sin ( 0 / L ) ) & & \\ & & & & & ⋱ & \\ & & & & & & {p}_{M - 1} ( sin ( ( L - 1 ) / L ) )\end{matrix} ) .$$

Other arguments, xₗ, having different forms may also be used (the above examples use xₗ=l/L and xₗ=sin (l/L) respectively).

Block encodings U and U′ can be implemented using techniques that are common general knowledge to one skilled in the art (for example using the techniques in Watts et al., Efficient amplitude encoding of polynomial functions into quantum computers, July 2023, arXiv:2307.10917v3 [quant-ph], and McArdle et al., Quantum state preparation without coherent arithmetic, October 2022, arXiv:2210.14892v1 [quant-ph] respectively, both of which are hereby incorporated by reference). Likewise, the multi-controlled rotations in FIG. 3 can also be implemented using techniques that are common general knowledge to one skilled in the art, such as those disclosed in, arXiv:quant-ph/0406176v5, Babbush et al., Encoding Electronic Spectra in Quantum Circuits with Linear T Complexity, Physical Review X, 8(4):041015, October 2018, DOI: 10.1103/PhysRevX.8.041015, and Hao Low et al., Trading T-gates for dirty qubits in state preparation and unitary synthesis, December 2018, arXiv:1812.00954v1 [quant-ph], all of which are hereby incorporated by reference.

Existing approaches for approximating quantum states fit a single high-degree polynomial to all state variables. Compared to these approaches, the present invention facilitates improved approximation (more granular fitting/approximation can be achieved by focusing on subsets of state variables rather than attempting to approximate all state variables with a single polynomial) with lower-degree polynomials (which are generally easier/faster to fit compared to higher-degree polynomials). In addition, many quantum states of interest have a natural grouping of values corresponding to a size value of a physical system of interest. For example, a quantum state may include values representing a two-dimensional (or higher dimensional) physical parameter, such as pressure. When represented as a two-dimensional data array, such values will generally be relatively smooth (i.e. relatively small changes between adjacent values). However, when the data is transposed into a one-dimensional quantum state (which is a vector rather than a two-dimensional matrix), large transitions can occur between adjacent values where transitions between matrix rows occur. Finding polynomial approximations that accommodate such transitions is difficult and generally reduces the accuracy of the fitting. However, the present invention can split the state variables into subsets based on the size value (i.e. a size the original array, such as the width/number of columns) such that each subset contains only smooth transitions between adjacent values.

Any method described herein may be provided as a computer program product and/or on one or more computer readable media such as one or more non-transitory computer readable media.

Having thus described several aspects of at least one embodiment of this disclosure, it is to be appreciated that various alterations, modifications, and improvements will readily occur to those skilled in the art. For instance, aspects of the techniques described herein may be combined in any of the following ways:

Example 1. A quantum computing system comprising: a compiling system; and a quantum processing unit comprising a control system coupled to a plurality of quantum devices, wherein the compiling system is configured to: receive a quantum state specification comprising a plurality of state variables defining a quantum state; determine a compressed representation of the quantum state, wherein determining the compressed representation of the quantum state comprises: splitting the plurality of state variables into a plurality of state variable subsets; and determining a respective polynomial approximation representing each respective subset of the plurality of state variable subsets, and send the compressed representation to the control system, and wherein the control system is configured to: receive the compressed representation of the quantum state; and use the compressed representation to prepare the plurality of quantum devices according to the quantum state.

Example 2. The quantum computing system of example 1, wherein the plurality of state variables has an associated size value, and wherein a size of each of the plurality of state variable subsets is equal to the size value.

Example 3. The quantum computing system of example 1 or example 2, wherein the quantum devices are qubits.

Example 4. The quantum computing system of any preceding example, wherein all respective polynomial approximations have equal polynomial degree.

Example 5. The quantum computing system of any preceding example, wherein each polynomial approximation comprises a respective plurality of polynomial coefficients.

Example 6. The quantum computing system of any preceding example, wherein a total number of polynomial coefficients associated with all respective polynomial approximations is less than a total number of state variables in the plurality of state variables.

Example 7. The quantum computing system of any preceding example, wherein all respective state variable subsets have equal size.

Example 8. The quantum computing system of any preceding example, wherein each respective state variable subset comprises a plurality of sequential state variables.

Example 9. A method of initialising a plurality of quantum devices in a quantum computing system, the method comprising: receiving, at a compiling system of the quantum computing system, a quantum state specification comprising a plurality of state variables defining a quantum state; determining, at the compiling system, a compressed representation of the quantum state, wherein determining the compressed representation of the quantum state comprises: splitting the plurality of state variables into a plurality of state variable subsets; and determining a respective polynomial approximation representing each respective subset of the plurality of state variable subsets, sending the compressed representation from the compiling system to a control system of the quantum computing system; and using the compressed representation, at the control system, to prepare the plurality of quantum devices according to the quantum state.

Example 10. The method of example 9, wherein the plurality of state variables has an associated size value, and wherein a size of each of the plurality of state variable subsets is equal to the size value.

Example 11. The method of example 9 or claim 10, wherein the quantum devices are qubits.

Example 12. The method of any of examples 9 to 11, wherein all respective polynomial approximations have equal polynomial degree.

Example 13. The method of any of examples 9 to 12, wherein each polynomial approximation comprises a respective plurality of polynomial coefficients.

Example 14. The method of any of examples 9 to 13, where a total number of polynomial coefficients associated with all respective polynomial approximations is less than a total number of state variables in the plurality of state variables.

Example 15. The method of any of examples 9 to 14, wherein all respective state variable subsets have equal size.

Example 16. The method of any of examples 9 to 15, wherein each respective state variable subset comprises a plurality of sequential state variables.

Example 17. A computer-readable medium comprising instructions which, when executed by a quantum computing system, cause the quantum computing system to carry out the method of any of examples 9 to 16.

It should be understood that any method of the present disclosure could include additional steps not described herein, and that any device of the present disclosure could include additional components not described herein. In addition, unless indicated otherwise or technically infeasible, the method steps disclosed herein may be performed in alternative orders, and any order described herein should be considered as illustrative rather than limiting. As a non-limiting example, the step of receiving the syndrome data in FIG. 8 need not occur at the start of the process but could occur any time prior to determining the correction. The illustrated steps and components could be split into multiple sub-steps/subcomponents.

The present disclosure may be used with any quantum error correction code that utilises a decoding hypergraph (e.g. a decoding graph), such as a surface code (e.g. planar code) or other topological quantum error correction code.

Aspects of the above-described embodiments of the technology described herein can be implemented in any of numerous ways. For example, aspects of the embodiments may be implemented using hardware, software, or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semi-custom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Furthermore, one skilled in the art will appreciate that any computation that can be performed by a classical processing device can also be performed by a quantum computing device. Accordingly, any methods or described herein that is performed on a classical computing device (such as a CPU) can also be performed by a quantum processing device, such as a quantum processing unit (QPU) comprising a plurality of qubits.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A quantum computing system comprising:
a compiling system; and
a quantum processing unit comprising a control system coupled to a plurality of quantum devices,
wherein the compiling system is configured to:
receive a quantum state specification comprising a plurality of state variables defining a quantum state;
determine a compressed representation of the quantum state, wherein determining the compressed representation of the quantum state comprises:
splitting the plurality of state variables into a plurality of state variable subsets; and
determining a respective polynomial approximation representing each respective subset of the plurality of state variable subsets, and
send the compressed representation to the control system, and
wherein the control system is configured to:
receive the compressed representation of the quantum state; and
use the compressed representation to prepare the plurality of quantum devices according to the quantum state.

2. The quantum computing system of claim 1, wherein the plurality of state variables has an associated size value, and wherein a size of each of the plurality of state variable subsets is equal to the size value.

3. The quantum computing system of claim 1, wherein the plurality of quantum devices is a plurality of qubits.

4. The quantum computing system of claim 1, wherein all respective polynomial approximations have equal polynomial degree.

5. The quantum computing system of claim 1, wherein each polynomial approximation comprises a respective plurality of polynomial coefficients.

6. The quantum computing system of claim 1, wherein a total number of polynomial coefficients associated with all respective polynomial approximations is less than a total number of state variables in the plurality of state variables.

7. The quantum computing system of claim 1, wherein all respective state variable subsets have equal size.

8. The quantum computing system of claim 1, wherein each respective state variable subset comprises a plurality of sequential state variables.

9. A method of initialising a plurality of quantum devices in a quantum computing system, the method comprising:
receiving, at a compiling system of the quantum computing system, a quantum state specification comprising a plurality of state variables defining a quantum state;
determining, at the compiling system, a compressed representation of the quantum state, wherein determining the compressed representation of the quantum state comprises:
splitting the plurality of state variables into a plurality of state variable subsets; and
determining a respective polynomial approximation representing each respective subset of the plurality of state variable subsets,
sending the compressed representation from the compiling system to a control system of the quantum computing system; and
using the compressed representation, at the control system, to prepare the plurality of quantum devices according to the quantum state.

10. The method of claim 9, wherein the plurality of state variables has an associated size value, and wherein a size of each of the plurality of state variable subsets is equal to the size value.

11. The method of claim 9, wherein the plurality of quantum devices is a plurality of qubits.

12. The method of claim 9, wherein all respective polynomial approximations have equal polynomial degree.

13. The method of claim 9, wherein each polynomial approximation comprises a respective plurality of polynomial coefficients.

14. The method of claim 9, where a total number of polynomial coefficients associated with all respective polynomial approximations is less than a total number of state variables in the plurality of state variables.

15. The method of claim 9, wherein all respective state variable subsets have equal size.

16. The method of claim 9, wherein each respective state variable subset comprises a plurality of sequential state variables.

17. A computer-readable medium comprising instructions which, when executed by a quantum computing system, cause the quantum computing system to carry out the method of claim 9.
